(19) United States
(12) Patent Application Publication
(10) Pub. No.: US 2026/0093005 A1
(43) Pub. Date: Apr. 2, 2026

(54) LIDAR AND BLUETOOTH SENSOR FUSION IN GENERATING LOCATION-BASED MODELS OF SIGNAL TRANSMISSION IN AN INDOOR ENVIRONMENT

(71) Applicant: NAGRAVISION SARL, Cheseaux-sur-Lausanne (CH)

(72) Inventors: Amine EL MLAHEG, Cheseaux-sur-Lausanne (CH); Luca GRADASSI, Cheseaux-sur-Lausanne (CH)

(73) Assignee: NAGRAVISION SARL, Cheseaux-sur-Lausanne (CH)

(21) Appl. No.: 18/904,141

(22) Filed: Oct. 2, 2024

(51) Int. Cl. G01S 5/02

(52) U.S. Cl. CPC G01S 5/02522; G01S 5/02524

(57) ABSTRACT

The present disclosure is directed to methods for generating a radiofrequency map of an indoor location using LIDAR and Bluetooth sensor fusion. The methods can include fusion of received signal strength indicator (RSSI) data and location data received from devices in an indoor environment. A map of predicted RSSI data corresponding to locations in the indoor environment can be generated based on the fusion of the received data using an artificial intelligence model. The map of predicted RSSI data can then be used to determine the location of devices within the indoor environment.

### BACKGROUND

### Field of the Disclosure

The present disclosure relates to mapping of indoor environments.

### Description of the Related Art

Determining the location of a radiofrequency transceiver in an indoor environment is complicated by interference within the indoor environment and the limited accuracy of traditional positioning systems.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

In one embodiment, the present disclosure is directed to a method for generating a radiofrequency map, comprising receiving, via processing circuitry, a set of received signal strength indicator (RSSI) data from a first device in an indoor environment based on signals received by the first device from one or more transmitters in the indoor environment; receiving, via the processing circuitry, sensor data from the first device in the indoor environment; determining, via the processing circuitry, location data of the first device in the indoor environment based on the sensor data; and generating, via the processing circuitry, a map of predicted RSSI data corresponding to locations in the indoor environment using an artificial intelligence model, the artificial intelligence model being trained on training data, the training data including the received set of RSSI data and the location data.

In one embodiment, the present disclosure is directed to processing circuitry configured to receive a set of received signal strength indicator (RSSI) data from a first device in an indoor environment based on signals received by the first device from one or more transmitters in the indoor environment, receive sensor data from the first device in the indoor environment, determine location data of the first device in the indoor environment based on the sensor data, and generate a map of predicted RSSI data corresponding to locations in the indoor environment using an artificial intelligence model, the artificial intelligence model being trained on the received set of RSSI data and the location data.

In one embodiment, the present disclosure is directed to a non-transitory computer-readable storage medium for storing computer-readable instructions that, when executed by a computer, cause the computer to perform a method, the method comprising receiving a set of received signal strength indicator (RSSI) data from a first device in an indoor environment based on signals received by the first device from one or more transmitters in the indoor environment; receiving sensor data from the first device in the indoor environment; determining location data of the first device in the indoor environment based on the sensor data; and generating a map of predicted RSSI data corresponding to locations in the indoor environment using an artificial intelligence model, the artificial intelligence model being trained on training data, the training data including the received set of RSSI data and the location data.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic of a networked system for predicting signal strength data, according to an embodiment of the present disclosure;

FIG. 2 is a schematic of an indoor environment having radiofrequency (RF) devices, according to an embodiment of the present disclosure;

FIG. 3 is a map of an indoor environment, according to an embodiment of the present disclosure;

FIG. 4 is a schematic of an indoor environment, according to an embodiment of the present disclosure;

FIG. 5 is a method of generating a map of predicted signal strength, according to an embodiment of the present disclosure;

FIG. 6 is a schematic of a user device for performing a method, according to an embodiment of the present disclosure;

FIG. 7 is a schematic of a hardware system for performing a method, according to an embodiment of the present disclosure; and

FIG. 8 is a schematic of a hardware configuration of a device for performing a method, according to an embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

In one embodiment, the present disclosure is directed to systems and methods for predicting signal data in indoor environments. The indoor environment can be any enclosed or partially enclosed environment, such as a room, building, mode of transportation (ship, airplane, train, vehicle, etc.), arena, etc. The predicted signal data (e.g., radiofrequency signal strength) can be dependent on a location in the indoor environment. For example, the indoor environment can include one or more radiofrequency (RF) devices configured to transmit or receive RF signals. The RF devices can be referred to herein as RF beacons or RF anchors. In one embodiment, the RF anchors can be placed in indoor environments at known/predetermined locations. The RF anchors can transmit RF signals of a known frequency and/or in a known pattern (e.g., continuous, pulsed) to RF signal receivers. The strength of an RF signal attenuates over space and is further affected by any objects, especially metal objects, between an RF anchor and an RF signal receiver. This attenuation can be common in an indoor environment such as a building, where walls, furniture, and other objects are dispersed throughout the environment. Therefore, different locations within the indoor environment can be subject to different RF signal strengths. RF signal strength can be indicated by a received signal strength indicator (RSSI). The RSSI of an RF signal receiver at a location can be a combined signal strength of intersecting signals transmitted by more than one anchor. The RSSIs of locations within an environment can be predicted in order to generate a comprehensive map of signal strength within the indoor environment. The prediction of signal strength can eliminate the need for exhaustive collection of empirical signal strength data within the indoor environment in order to characterize signal propagation in the indoor environment.

In one embodiment, the map of predicted signal strength can be used to locate devices within the indoor environment. For example, a receiver device (e.g., an RF receiver) within the indoor environment can receive RF signals having a particular RSSI from one or more RF anchors. A map of predicted signal strengths can be generated based on known location data and signal data collected in the indoor environment. The particular RSSI can be compared to the predicted signal strengths at locations in the indoor environment in order to accurately determine the location of the receiver device.

In one embodiment, the map can be generated using artificial intelligence. In one embodiment, the map can be generated via at least one prediction model (a mapping model). In one embodiment, the mapping model can be a machine learning model. The mapping model can be trained to predict signal strength at locations within the indoor environment based on. In one embodiment, the mapping model can be trained using a supervised learning technique. In one embodiment, the mapping model can be trained using semi-supervised or unsupervised learning. In one embodiment, the mapping model can predict signal strength data based on acquired (received) signal strength data acquired at locations in the indoor environment. The mapping model can be trained to predict signal strength at locations in addition to the locations included in the training data. The predicted signal strength can then be used to generate a comprehensive signal strength map of the indoor environment.

In one embodiment, the signal strength data and the sensor data can be acquired by an electronic device (a scanning device, a first device) during a scan of the environment. The scanning device can include, but is not limited to, a mobile phone or device, tablet, computer, wearable device, etc. The signal strength data and the sensor data can be transmitted by the scanning device to a mapping server, wherein the mapping server is configured to generate the map of predicted signal strengths. The mapping server can be a computer, a server, etc. The mapping server can receive the signal strength data and the sensor data and can generate the mapping data (dataset) based on the (acquired and predicted) signal strength data and the sensor data.

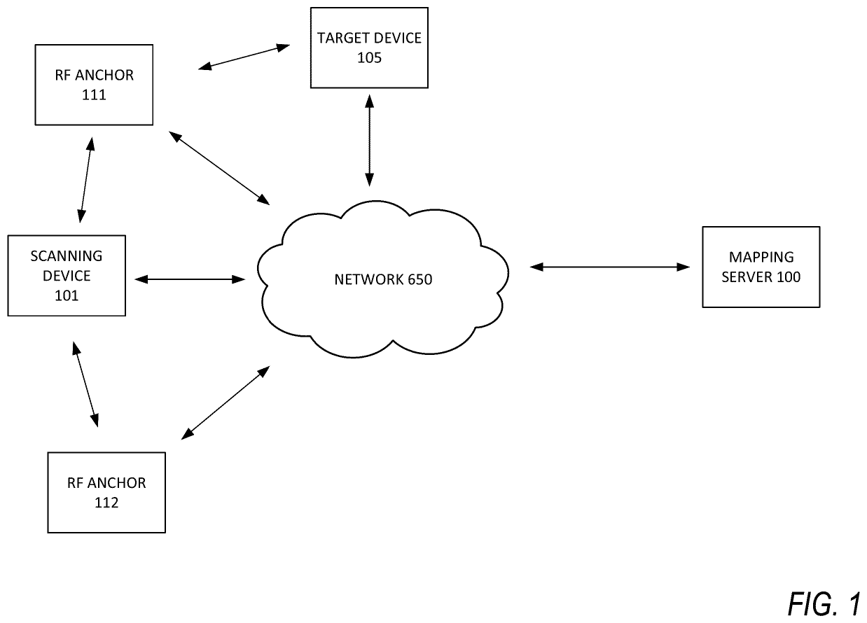

FIG. 1 is a schematic of devices in network communication according to one embodiment of the present disclosure. The scanning device 101 can be in network communication with the mapping server 100 via a communication network 650. The network 650 can be a wireless communication network. The scanning device 101 can acquire sensor data and/or signal strength data and can transmit the data to the mapping server 100. The mapping server 100 can use the received data to generate the map of predicted signal strength. The mapping server 100 can train and run a machine learning model to generate the map. In one embodiment, the RF signals received by the scanning device 101 can be transmitted by one or more RF anchors (111, 112) in the indoor environment. It can be appreciated that the indoor environment can include any number of RF anchors. An RF anchor can be a device configured to transmit and/or receive a signal. The signal can include an identifier of the RF anchor. In one embodiment, the signal can include location data of the transmitting RF anchor. In one embodiment, the RF anchor can be a Bluetooth beacon. In one embodiment, the RF anchors 211, 212 can be in network communication with each other. In one embodiment, the RF anchors can be in network communication with the mapping server 100.

In one embodiment, a map of predicted signal strength in an indoor environment can be used to locate a target device 105 in the indoor environment. The target device 105 can be configured to transmit and/or receive RF signals to and/or from the RF anchors 211, 212. The target device 105 can transmit signal data, including RSSI data, to the mapping server 100. The mapping server 100 can determine a location of the target device 105 in the indoor environment by comparing the RSSI data from the target device 105 to predicted signal strength values in the indoor environment generated by the mapping server 100. In one embodiment, the target device 105 can be in network communication with a second server (not pictured). The second server (location server) can receive the map of predicted signal strength from the mapping server 100 and signal strength data from the target device 105. The location server can then locate the target device 105. In one embodiment, the mapping server 100 can use a positioning model to determine the location of the target device 105 in the indoor environment based on signal strength data received from the target device 105. In one embodiment, the positioning model can be a machine learning model such as a classifier. The positioning model can be trained to predict a location based on signal strength data using the mapping data including acquired signal strength data from the scanning device 101 and predicted signal strength data generated by the mapping model.

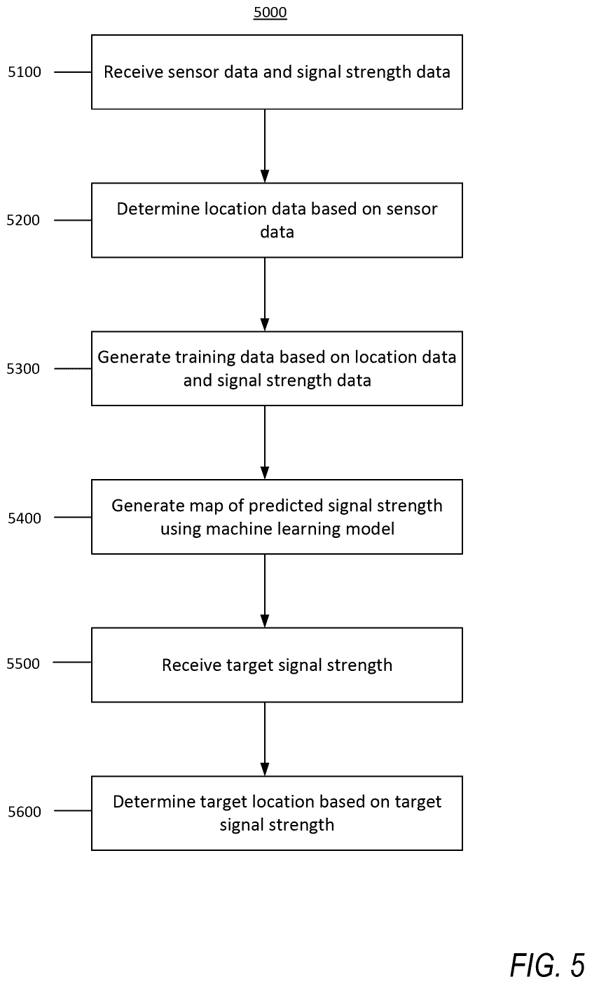

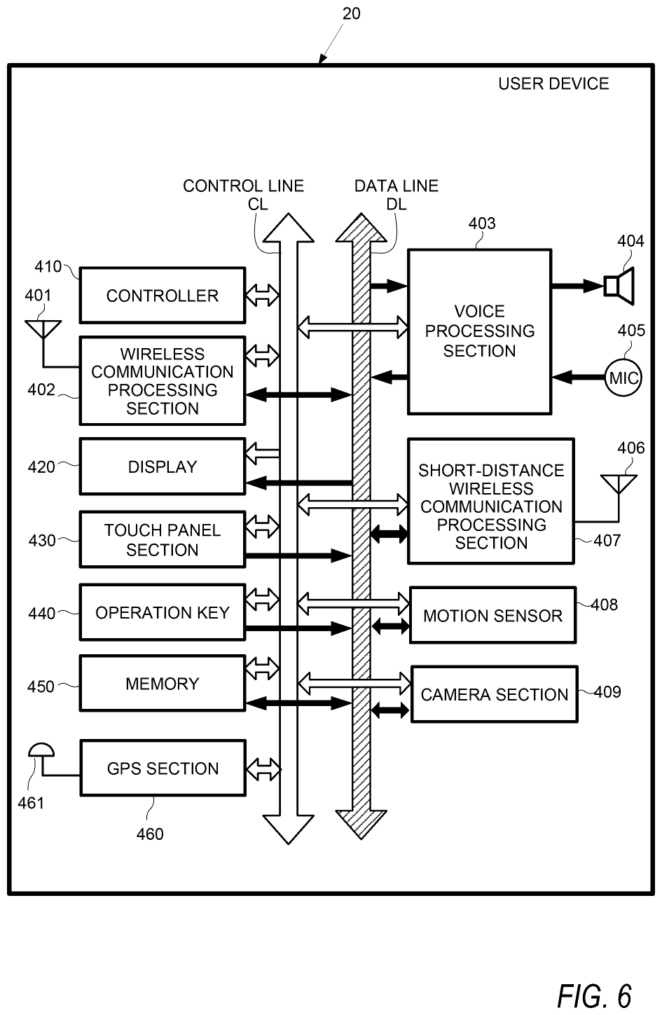

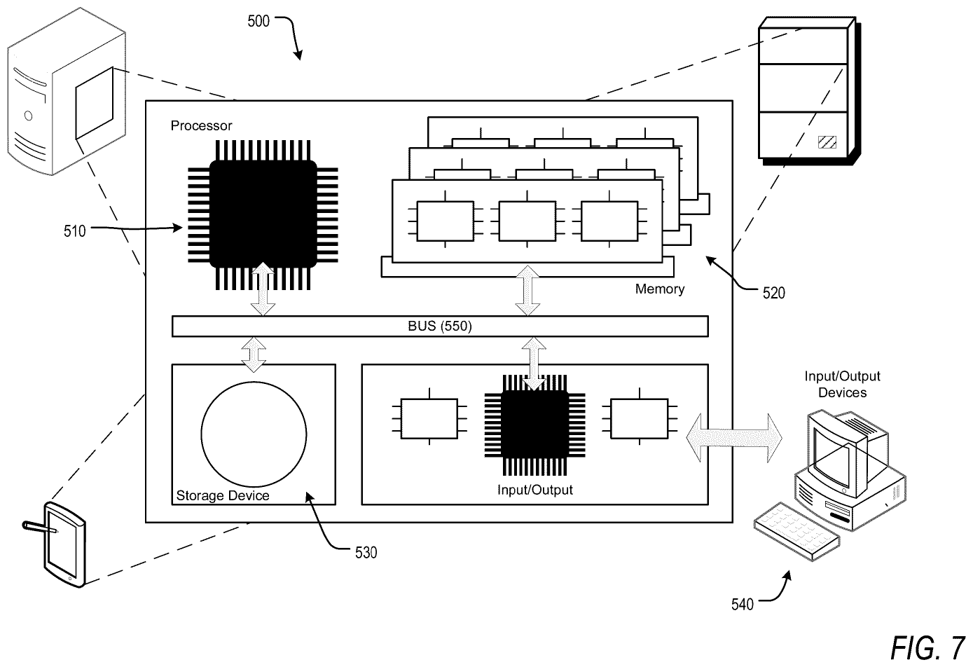

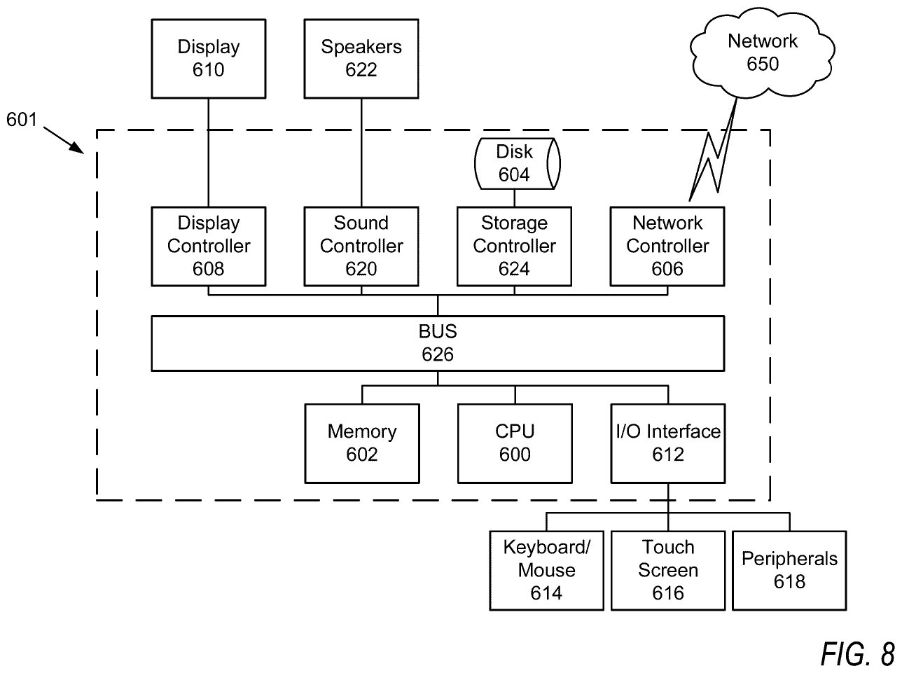

Each of the devices illustrated in FIG. 1 can include processing circuits/processing circuitry, the processing circuitry including one or more processors, controllers, programmed processing units (e.g., central processing units (CPUs)), integrated circuits, etc. The processes and methods described herein can be executed by processing circuitry in the respective devices. Examples of processing circuits and components thereof are further described herein with reference to FIGS. 6-8. In one embodiment, the scanning device 101 can include any of the components illustrated in FIG. 8. In one embodiment, the scanning device 101 can be a user device 20, e.g., a mobile device, illustrated in FIG. 6. In one embodiment, the mapping server 100 can be a computer or server similar to the illustration of FIG. 7. The mapping server can include processing circuitry configured to perform the method of generating a map of predicted signal strength and predict a location of a target device according to FIG. 5. In one embodiment, the RF anchors 111, 112 and the target device 105 can include any of the components illustrated in FIG. 8, including processing circuitry configured for signal reception, processing, and transmission.

In one embodiment, the sensor data can include at least one of light detection and ranging (LIDAR) data, accelerometer data, altitude data, orientation data, gyroscope data, and/or imaging data collected by the scanning device 101. In one embodiment, the sensor data can be data that is used to determine a position or location of the scanning device 101. The position or location can be an absolute position or a relative position. For example, the sensor data can include LIDAR data that is used to generate a three-dimensional (3D) model (e.g., a point cloud representation) of the environment surrounding the scanning device 101. In one embodiment, the scanning device 101 or the mapping server 100 can associate accelerometer data, gyroscope data, and/or imaging data from the scanning device 101 with the LIDAR data to determine additional information about the scanning device 101. For example, the sensor data can be used to determine an orientation of the scanning device when the LIDAR data is collected. In one embodiment, the scanning device 101 or the mapping server 100 can correct, normalize, or otherwise process the sensor data in order to generate an accurate 3D model of the indoor environment. In one embodiment, the mapping server 100 can associate types of sensor data with each other using timestamps associated with the sensor data.

In one embodiment, signal strength data and the sensor data can be acquired by the scanning device 101 during a scan of the indoor environment. In one embodiment, the scanning device 101 can acquire signal strength data (e.g., RSSI values) and sensor data while moving through the indoor environment. In one embodiment, the signal strength data and/or sensor data can be acquired when the scanning device 101 is stationary. In one embodiment, the sensor data acquired at a location can be acquired at more than one orientation or position of the scanning device 101. In one embodiment, the sensor data of the scanning device can be used to generate a 3D representation of the indoor environment, e.g., a point cloud.

In one embodiment, the sensor data can include a location of the scanning device 101. For example, the sensor data can include a point in a point cloud at which the scanning device 101 is located. The point can be, for example, a set of coordinates in three-dimensional space. In one embodiment, the point can be associated with a set of signal strength data at the location of the scanning device 101.

In one embodiment, the mapping server can determine a location of the scanning device 101 based on the sensor data. The location of the scanning device 101 can include one or more discrete locations within the indoor environment. The mapping server 100 can generate the 3D model of the indoor environment based on the sensor data. The mapping server 100 can determine location(s) within the model of the indoor environment at which the sensor data is collected by the scanning device. In one embodiment, the location of the scanning device can be a location in a coordinate system. Additionally or alternatively, the location of the scanning device can be a relative location. For example, the location can be relative to structures (e.g., walls) or objects in the indoor environment.

In one embodiment, the signal strength data acquired by the scanning device 101 can include RSSIs of signals that are transmitted to the scanning device scanning by one or more RF anchors 111. The RF anchors 111 can include, for example, Bluetooth (BLE) transmitters. In one embodiment, the RF anchors 111 can transmit signals over a variety of radio protocols and corresponding frequencies, including, but not limited to, WIFI, ultra-wideband (UWB), Zigbee, etc. In one embodiment, the signals can be modulated signals. In one embodiment, the RF anchors 111 can be distributed in the indoor environment. The signal received by the scanning device 101 can be an aggregate signal from more than one RF anchor. For example, signals from different RF anchors can overlap and constructively or destructively interfere with each other at locations throughout the indoor environment. The signal strength detected by the scanning device 101 can therefore be the combined signal strength of signals from more than one RF anchor.

The mapping server 100 can employ data fusion to generate training data, the training data including location data and signal strength data. The location data can include the location(s) of the scanning device 101 during the scan of the indoor environment. In one embodiment, the mapping server 100 can associate the location data with the signal strength data based on timestamps in the sensor data and/or the signal strength data. RF signals can be timestamped when they are transmitted by a transmitting device (e.g., the RF anchors). A device receiving an RF signal can also record a time when the signal is received. The time when the signal is received can be transmitted to the mapping server 100 as part of the signal strength data.

The mapping server 100 can fuse a coordinate location of the scanning device 101 with signal strength at that coordinate location. In one embodiment, a timestamp of the signal strength data can match a timestamp of the sensor data within a margin of difference (e.g., milliseconds, one second, five seconds). In one embodiment, the signal strength data and the sensor data can be asynchronous. In one embodiment, the mapping data can be a combined dataset of the location data and the signal strength data. Each entry in the set of mapping data can be a set of coordinates defining a location of the scanning device 101 in the indoor environment. For example, the location can be defined by two-dimensional coordinates (e.g., x and y coordinates) or three-dimensional coordinates (e.g., x, y, z). In one embodiment, the coordinates can be modulated by the RSSI at the location.

In one embodiment, the signal strength data and the sensor data can be received from separate devices. In one embodiment, the signal strength data can include signal strength data received from the same device transmitting the sensor data (the scanning device 101) and/or signal strength data received from a different device (a second device) from the device transmitting the sensor data. In one embodiment, the second device can be an RF anchor 111, 112 configured to receive signals from the scanning device 101. In one embodiment, the second device can be an RF receiver. In one embodiment, the scanning device 101 can transmit RF signals during the scan of the indoor environment. In one embodiment, the transmission of RF signals from the scanning device 101 can be synchronized with the acquisition of sensor data by the scanning device 101. The second device can receive the signals from the scanning device 101 and can transmit signal strength data (e.g., RSSI data) of the signals to the mapping server. In one embodiment, the indoor environment can include one or more second devices in communication with each other. For example, the one or more second devices can be the RF anchors 111, 112. A signal received by a first RF anchor 111 can be a combination of signals transmitted from the scanning device 100 and signals transmitted from other RF anchors 112 in the indoor environment. The signal strength data can be a combined signal strength of more than one signal received by the RF anchor 111.

In one embodiment, the location of the second device (e.g., the RF anchors) can be transmitted to or stored in the mapping server 100. The location of the second device can be a fixed location in the indoor environment. In one embodiment, the mapping server 100 can associate the signal strength data received from a second device with the location data corresponding to the scanning device 101 to generate the training data. In one embodiment, the location data of the scanning device 101 can include locations where the scanning device 101 transmitted the RF signals that were received by the second device.

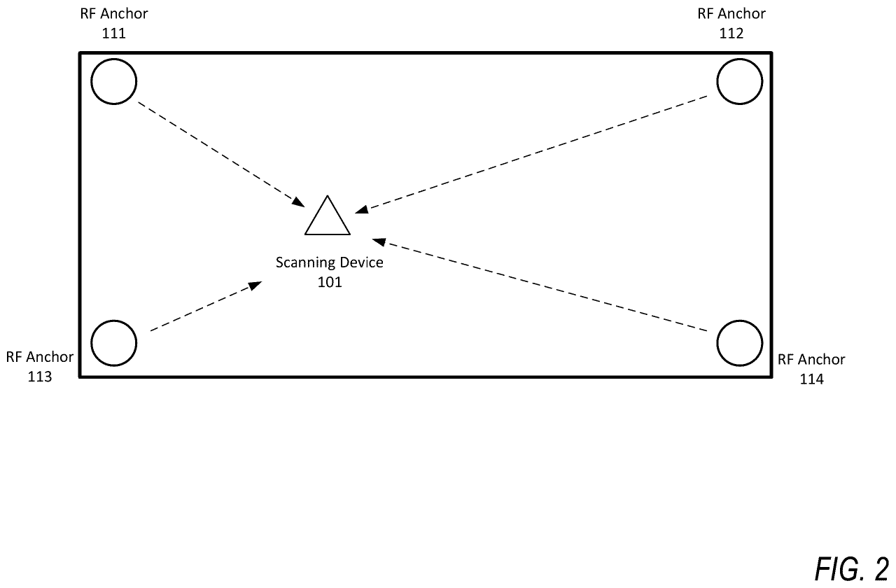

FIG. 2 is a schematic of an indoor environment including a scanning device 101 and RF anchors 111, 112, 113, 114, according to one embodiment of the disclosure. The indoor environment can include one or more partitions between areas. The scanning device 101 can receive signals from each of the RF anchors 111, 112, 113, 114. Each signal can have an RSSI. The scanning device 101 can transmit the RSSI of the signals received from the RF anchors 111, 112, 113, 114 to the mapping device. The scanning device 101 can also acquire sensor data, e.g., LIDAR data. The sensor data can be used to determine a location of the scanning device 101 in coordinates (x, y, z). The scanning device 101 can transmit the sensor data and/or location data to the mapping server 100.

In one embodiment, the signal strength data can include data that is collected over time at a single location in the indoor environment. Signal strength can vary over time due to variation in the signals transmitted by the RF anchors. In one embodiment, the mapping server 100 can predict signal strength as a function of time. The measure of time in the predicted signal strength can be relative or absolute. For example, the measure of time can be an amount of time that has elapsed since an initial point in time, e.g., when an RF anchor begins transmitting a signal.

In one embodiment, the original strength of a transmitted signal can be used to determine a signal attenuation. For example, the mapping server 100 can determine a difference between a signal's strength when it is transmitted by an RF anchor 111 and when it is received by the scanning device 101. In one embodiment, the mapping server 100 can use the machine learning model to determine an attenuation of individual signals that are simultaneously received by the scanning device 101. In one embodiment, the mapping server 100 can use the attenuation data to determine a distance between the scanning device 101 and an RF anchor 111 and/or the location of any interference between the devices.

In one embodiment, the mapping model can classify sensor data received from the scanning device 101. In one embodiment, the mapping model can classify the sensor data into regions of the indoor environment. For example, the sensor data can include LIDAR data that is used to generate a point cloud representation of obstacles in the indoor environment. The obstacles can include structures (e.g., walls, doorways), objects, etc. A point in the point cloud can correspond to a point in three-dimensional space having a certain size or radius. The mapping model can classify the point cloud representations into zones within the indoor environment.

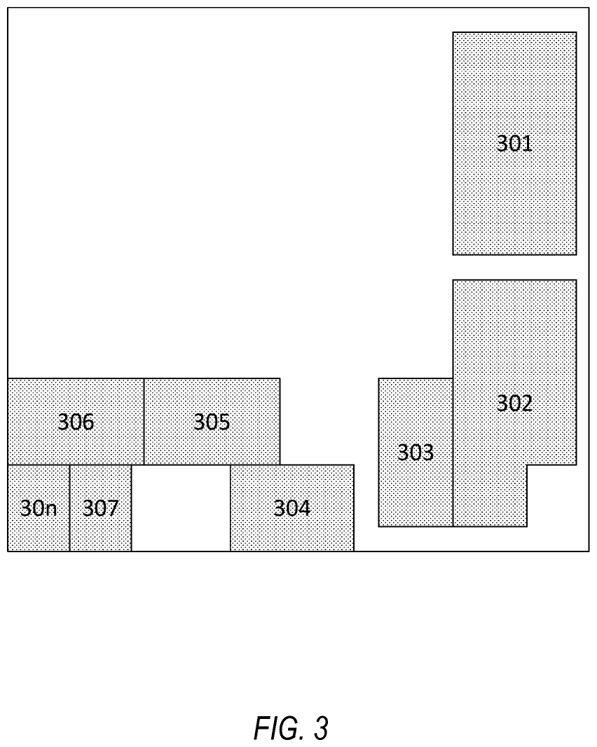

FIG. 3 is an example of a classification output of the mapping model. The mapping model can classify sensor data into zones 301, 302, . . . 30n in a map of the indoor environment. The zones can be bounded areas in three-dimensional space. In one embodiment, the boundaries of the zones can be predetermined (e.g., input to the mapping model) or can be determined by the mapping model based on the received sensor data and signal strength data. For example, in FIG. 3, each zone can correspond to a room in the indoor environment. In one embodiment, the classification of the sensor data can include the zone in which the scanning device 101 is located when the sensor data is collected. The points of the sensor data can then be attributed to an obstacle located in the zone. In one embodiment, the mapping model can include a k-nearest neighbor (KNN) model for classification of the sensor data.

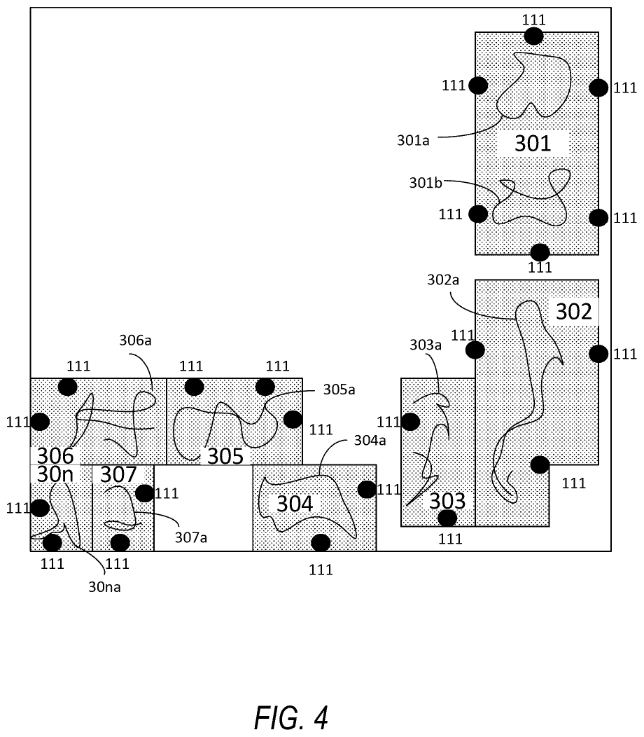

In one embodiment, the mapping model can interpolate signal strength data based on the sensor data and the received (measured, acquired) signal strength data from the scanning device 101. In one embodiment, the mapping model can interpolate signal strength data for points in space that are mapped by the sensor data (e.g., the point cloud). The interpolated signal strength data can then be used as training data for the positioning model. In general, the sensor data can include data corresponding to points in space where signal strength data is not known. For example, as illustrated in FIG. 4, the sensor data can include LIDAR data that is acquired from throughout the indoor environment by a scanning device 101 traversing a route through the indoor environment. The scanning device 101 can further transmit signal strength data based on RF signals received from the RF transmitters 111 in the indoor environment. The signal strength data acquired by the scanning device 101 may only correspond to points along the route of the scanning device 101. For example, in zone 301, the scanning device 101 can acquire signal strength data at points along routes 301 and 301b; in zone 302, the scanning device 101 can acquire signal strength data at points along route 302a; in zone 303, the scanning device 101 can acquire signal strength data at points along route 303a; etc. The sensor data (e.g., LIDAR data) can cover a larger portion of the zones than the signal strength data. The mapping model can spatially interpolate signal strength data for other points in the three-dimensional space that are represented by the point cloud. In one example, the training model can use a regression-based interpolation. For example, the mapping model can use kriging interpolation to output the predicted signal strength data. The mapping server 100 can then generate the map of predicted signal strength based on the output of the mapping model.

In one embodiment, the map of predicted signal strength can be used to locate a target device 105 in the indoor environment. The target device 105 can be an RF transceiver (transmitter or receiver) or can be any device configured for RF signal transmission and/or reception. The indoor environment can include one or more RF anchors 111, 112. The RF anchors can be devices that were present in the indoor environment when a scan of the indoor environment was conducted to acquire training data. The mapping model can generate a map of predicted signal strength in the indoor environment. At a later point in time, the target device 105 can receive RF signals from one or more of the RF anchors 111, 112 in the indoor environment. The mapping server 100 can then receive signal strength data from the target device 105 in the indoor environment indicating the combined strength of the RF signals received by the target device 105. The mapping server 100 can then use the map and/or the positioning model to determine the location of the target device 105 based on the received RF signal strength. In one embodiment, the positioning model can predict a location in the indoor environment based on signal strength data. For example, a target device 105 in an indoor environment can receive RF signals from RF transceivers and can transmit signal strength data to the mapping server 100. The received signal strength data can be input to the positioning model. The positioning model can be trained to predict the location of the target device 105 in the indoor environment based on the acquired signal strength data. In one embodiment, the positioning model can be trained to predict locations based on the mapping data including acquired and predicted signal strength data.

In one embodiment, the positioning model can be a machine learning model trained using artificial intelligence techniques, e.g., neural networks, deep learning. In one embodiment, the positioning model can be a regression-based model. In one embodiment, the positioning model can be a neural network, such as a convolutional neural network (CNN). The neural network can include one or more connected layers of neurons. In one embodiment, the positioning model can be trained via supervised learning. In one embodiment, the positioning model can be a classifier such as a support vector machine (SVM). The positioning model can be trained using the mapping data to classify signal strength data (input) to a corresponding location (output). In one embodiment, the machine learning model can extract features from the input data (signal strength data) and can transform the signal strength data into a feature representation such as a feature vector. The machine learning model can be trained to determine a function that can map features of the input data (signal strength) to an output (location data, e.g., x, y, z coordinates). The function can then be used to predict locations for new input data (signal strength data).

The mapping model can be used to generate a map of predicted signal strength in the indoor environment based on the training data. In one embodiment, the predicted signal strength can be overlaid on the 3D model of the indoor environment, the 3D model being generated based on the sensor data acquired by the scanning device 101. The mapping model can be used to predict the signal strength at locations in the indoor environment different from the locations included in the training data.

In one embodiment, the mapping model can be trained to model and predict RF signal propagation within the indoor environment. For example, the mapping model can be used to identify and/or predict areas of attenuation, which can correspond to metal structures or other sources of interference and signal deflection. The mapping model can model attenuation throughout the indoor environment. In one embodiment, the mapping model can be used to identify blind spots, or areas where signal strength is relatively weak, in the indoor environment.

In one embodiment, the mapping server 100 can input a floor plan or similar schematic of the indoor environment to the mapping model. The mapping model can combine the floor plan with the location data and the signal strength data to generate the map. For example, the floor plan can indicate walls, doors, and other structural elements in the indoor environment. The location of the structural elements can be used to generate a model of signal transmission and attenuation. In one embodiment, the floor plan can include locations of RF anchors in the indoor environment. For example, RF anchors can be placed throughout the indoor environment prior to a scan by the first device. The locations of the RF anchors can be received by or stored in the mapping server 100. The mapping server 100 can input the locations of the RF anchors to the machine learning model with the location data of the first device and the signal strength data. The location of the RF anchors can be used to predict signal strength at a location based on a distance from one or more RF anchors in the indoor environment.

In one embodiment, the mapping model and/or the positioning model can be used to predict signal strength in the indoor environment for an indoor environment configuration that is different from the configuration during the scan of the indoor environment. For example, there can be a number of RF anchors in the indoor environment during the acquisition of training data by the scanning device. The number and locations of the RF anchors can be input to the machine learning model during training. In one embodiment, the mapping model can be trained to predict signal strength in the indoor environment for a different number or locations of the RF anchors. For example, the mapping model can be used to predict signal strength in the indoor environment when one of the RF anchors in the indoor environment is removed or disabled. The mapping model can therefore be used to accurately predict signal strength in different indoor environment configurations based on a training data for a single configuration.

FIG. 5 is a method 5000 of locating a target device 105 using a map of predicted signal strength according to one embodiment. In step 5100, the mapping server 100 can receive sensor data and the signal strength data from the scanning device. The sensor data and the signal strength data can be acquired by the scanning device 101 during a scan of the indoor environment. In step 5200, the mapping server 100 can determine locations of the scanning device 101 during the scan of the indoor environment. In step 5300, the mapping server 100 can input the sensor data, the signal strength data, and the location data to a mapping model. In step 5400, the mapping model can predict signal strength in the indoor environment based on the input data and can generate a map of predicted signal strength in the indoor environment.

In step 5500, the mapping server 100 can receive signal strength data from a target device 105 in the indoor environment. The signal strength data can be referred to as target signal strength. The target device 105 can be an RF transceiver, transmitter, or receiver. In one embodiment, the target device 105 can be a key finder or similar electronic device. The target device 105 can receive RF signals from the RF anchors 111, 112, in the indoor environment. In one embodiment, the configuration of RF anchors 111, 112 in the indoor environment can be the same configuration present when the signal strength data is received in step 5100. The target signal strength can indicate the combined strength of the RF signals received by the target device 105. In one embodiment, the target signal strength can include signal strength data that has been collected by the target device 105 over time. Additionally or alternatively, the mapping server can receive signal strength data from the RF anchors as target signal strength in step 5500.

In step 5600, the mapping server 100 can identify a target location based on the target signal strength received in step 5500. The mapping server 100 can determine the target location based on the map generated in step 5400. In one embodiment, the mapping server 100 can determine the target location using a positioning model. The target location can be a location in the indoor environment wherein the predicted signal strength matches the target signal strength. The predicted signal strength can be approximately the same as the target signal strength received in step 5500. In one embodiment, the predicted signal strength can be within a range of the target signal strength. In one embodiment, the target location can be defined by one or more coordinates. In one embodiment, the target location can be defined according to a structure, object, or area in the indoor environment. In this manner, the mapping server 101 can use the map of predicted signal strength to locate target devices in the indoor environment. In one embodiment, the mapping server 101 can determine whether there are devices (e.g., other target devices, RF anchors) within a certain proximity to the target device. The mapping server 101 can determine a distance between a target device and a second device such as a second target device or an RF anchor.

In one embodiment, the mapping server 101 can be in network communication with a locator device. The locator device can include one or more components of the user device 20 of FIG. 6. In one embodiment, the mapping server 101 can transmit data to the locator device after locating the target device. In one embodiment, the mapping server 101 can transmit the location of the target device to the locator device. For example, the mapping server 101 can transmit a map of the indoor environment to the locator device, wherein the location of the target device is indicated on the map. In one embodiment, the mapping server 101 can receive or determine a location of the locator device. In one example, the locator device can be located in the indoor environment. The mapping server 101 can generate directions from the location of the locator device to the determined location of the target device. The mapping server 101 can then transmit the directions to the locator device. In this manner, the mapping server 101 can provide data to the locator device to guide the locator device to the target device.

In one embodiment, the mapping server 101 can receive instructions from the locator device. For example, the locator device can transmit device identification data of the target device to the mapping server 101. The device identification data can include a serial number or characteristic associated with the target device. The mapping server 101 can then determine the location of the target device based on the target signal strength received from the target device. In one embodiment, the mapping server 101 can transmit a request to the target device for the target signal strength prior to determining the location of the target device.

In one embodiment, the mapping server 101 can transmit data to the target device after locating the target device. For example, the mapping server 101 can transmit the location of the target device to the target device. The target device can then transmit the location to another device (e.g., the locator device, the RF anchors). In one example, the data transmitted to the target device can include instructions for the target device.

The use of the machine learning model to predict signal strength throughout the indoor environment can reduce the amount of data that is needed to build an accurate map of the indoor environment. For example, the scan of the indoor environment can include less sensor data and/or less signal strength data than a traditional scan that is not input to a machine learning model. The reduced amount of data can reduce processing power needed by the scanning device 101 and/or the mapping server 100 and can also reduce time and labor costs. In addition, data transmission between the scanning device 101 and the mapping server 100 can also be reduced. Acquiring fewer data points in a scan of the indoor environment can also reduce time and labor costs while maintaining the mapping server's ability to generate an accurate map of signal strength throughout the indoor environment. The accuracy of the predicted signal strength improves the ability of the mapping server 101 to locate the target device based on signal strength data.

Embodiments of the subject matter and the functional operations described in this specification can be implemented by digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of data processing apparatus, such as the mapping server 100, the scanning device 101, the target device 105, the RF anchors 111, 112, and the like. The computer storage medium can be a machine-readable storage device, a machine-readable storage substrate, a random or serial access memory device, or a combination of one or more of them.

Each of the functions of the described embodiments can be implemented by one or more processing circuits/processing circuitry (may also be referred to as a controller). A processing circuit includes a programmed processor (for example, a CPU of FIG. 7), as a processor includes circuitry. A processing circuit can also include devices such as an application specific integrated circuit (ASIC) and circuit components arranged to perform the recited functions.

The term “data processing apparatus” refers to data processing hardware and may encompass all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, Subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA an ASIC.

Computers suitable for the execution of a computer program include, by way of example, general or special purpose microprocessors or both, or any other kind of central processing unit. Generally, a CPU will receive instructions and data from a read-only memory or a random access memory or both. Elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more Such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients (user devices) and servers. A client and server are generally remote from each other and typically interact through a communication network. The relationship of client and server arises by virtue of computer programs running on the respective computers and having a client-server relationship to each other. In an embodiment, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

Electronic user device 20 shown in FIG. 6 can be an example of one or more of the devices described herein, including the scanning device 101. In an embodiment, the electronic user device 20 may be a smartphone. However, the skilled artisan will appreciate that the features described herein may be adapted to be implemented on other devices (e.g., a laptop, a tablet, a server, an e-reader, a camera, a navigation device, etc.). The example user device 20 of FIG. 6 includes processing circuitry, as discussed above. The processing circuitry includes one or more of the elements discussed next with reference to FIG. 6. The electronic user device 20 may include other components not explicitly illustrated in FIG. 6 such as a CPU, GPU, frame buffer, etc. The electronic user device 20 includes a controller 410 and a wireless communication processor 402 connected to an antenna 401. A speaker 404 and a microphone 405 are connected to a voice processor 403.

The controller 410 may include one or more processors/processing circuitry (CPU, GPU, or other circuitry) and may control each element in the user device 20 to perform functions related to communication control, audio signal processing, graphics processing, control for the audio signal processing, still and moving image processing and control, and other kinds of signal processing. The controller 410 may perform these functions by executing instructions stored in a memory 450. Alternatively or in addition to the local storage of the memory 450, the functions may be executed using instructions stored on an external device accessed on a network or on a non-transitory computer readable medium.

The memory 450 includes but is not limited to Read Only Memory (ROM), Random Access Memory (RAM), or a memory array including a combination of volatile and non-volatile memory units. The memory 450 may be utilized as working memory by the controller 410 while executing the processes and algorithms of the present disclosure. Additionally, the memory 450 may be used for long-term storage, e.g., of image data and information related thereto.

The user device 20 includes a control line CL and data line DL as internal communication bus lines. Control data to/from the controller 410 may be transmitted through the control line CL. The data line DL may be used for transmission of voice data, displayed data, etc.

The antenna 401 transmits/receives electromagnetic wave signals between base stations for performing radio-based communication, such as the various forms of cellular telephone communication. The wireless communication processor 402 controls the communication performed between the user device 20 and other external devices via the antenna 401. For example, the wireless communication processor 402 may control communication between base stations for cellular phone communication.

The speaker 404 emits an audio signal corresponding to audio data supplied from the voice processor 403. The microphone 405 detects surrounding audio and converts the detected audio into an audio signal. The audio signal may then be output to the voice processor 403 for further processing. The voice processor 403 demodulates and/or decodes the audio data read from the memory 450 or audio data received by the wireless communication processor 402 and/or a short-distance wireless communication processor 407. Additionally, the voice processor 403 may decode audio signals obtained by the microphone 405.

The example user device 20 may also include a display 420, a touch panel 430, an operation key 440, and a short-distance communication processor 407 connected to an antenna 406. The display 420 may be a Liquid Crystal Display (LCD), an organic electroluminescence display panel, or another display screen technology. In addition to displaying still and moving image data, the display 420 may display operational inputs, such as numbers or icons which may be used for control of the user device 20. The display 420 may additionally display a GUI for a user to control aspects of the user device 20 and/or other devices. Further, the display 420 may display characters and images received by the user device 20 and/or stored in the memory 450 or accessed from an external device on a network. For example, the user device 20 may access a network such as the Internet and display text and/or images transmitted from a Web server.

The touch panel 430 may include a physical touch panel display screen and a touch panel driver. The touch panel 430 may include one or more touch sensors for detecting an input operation on an operation surface of the touch panel display screen. The touch panel 430 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 430 may detect when the stylus approaches/contacts the operation surface of the touch panel display (similar to the case in which a finger is used for the touch operation).

In certain aspects of the present disclosure, the touch panel 430 may be disposed adjacent to the display 420 (e.g., laminated) or may be formed integrally with the display 420. For simplicity, the present disclosure assumes the touch panel 430 is formed integrally with the display 420 and therefore, examples discussed herein may describe touch operations being performed on the surface of the display 420 rather than the touch panel 430. However, the skilled artisan will appreciate that this is not limiting.

For simplicity, the present disclosure assumes the touch panel 430 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 430 may include transparent electrode touch sensors arranged in the X-Y direction on the surface of transparent sensor glass.

The touch panel driver may be included in the touch panel 430 for control processing related to the touch panel 430, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in an embodiment, the touch panel 430 may detect a position of a user's finger around an edge of the display panel 420 (e.g., gripping a protective case that surrounds the display/touch panel). Signals may be transmitted by the touch panel driver, e.g., in response to a detection of a touch operation, in response to a query from another element based on timed data exchange, etc.

The touch panel 430 and the display 420 may be surrounded by a protective casing, which may also enclose the other elements included in the user device 20. In an embodiment, a position of the user's fingers on the protective casing (but not directly on the surface of the display 420) may be detected by the touch panel 430 sensors. Accordingly, the controller 410 may perform display control processing described herein based on the detected position of the user's fingers gripping the casing. For example, an element in an interface may be moved to a new location within the interface (e.g., closer to one or more of the fingers) based on the detected finger position.

Further, in an embodiment, the controller 410 may be configured to detect which hand is holding the user device 20, based on the detected finger position. For example, the touch panel 430 sensors may detect fingers on the left side of the user device 20 (e.g., on an edge of the display 420 or on the protective casing), and detect a single finger on the right side of the user device 20. In this scenario, the controller 410 may determine that the user is holding the user device 20 with his/her right hand because the detected grip pattern corresponds to an expected pattern when the user device 20 is held only with the right hand.

The operation key 440 may include one or more buttons or similar external control elements, which may generate an operation signal based on a detected input by the user. In addition to outputs from the touch panel 430, these operation signals may be supplied to the controller 410 for performing related processing and control. In certain aspects of the present disclosure, the processing and/or functions associated with external buttons and the like may be performed by the controller 410 in response to an input operation on the touch panel 430 display screen rather than the external button, key, etc. In this way, external buttons on the user device 20 may be eliminated in lieu of performing inputs via touch operations, thereby improving watertightness.

The antenna 406 may transmit/receive electromagnetic wave signals to/from other external apparatuses, and the short-distance wireless communication processor 407 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 407.

The user device 20 may include a motion sensor 408. The motion sensor 408 may detect features of motion (i.e., one or more movements) of the user device 20. For example, the motion sensor 408 may include an accelerometer to detect acceleration, a gyroscope to detect angular velocity, a geomagnetic sensor to detect direction, a geo-location sensor to detect location, etc., or a combination thereof to detect motion of the user device 20. In an embodiment, the motion sensor 408 may generate a detection signal that includes data representing the detected motion. For example, the motion sensor 408 may determine a number of distinct movements in a motion (e.g., from start of the series of movements to the stop, within a predetermined time interval, etc.), a number of physical shocks on the user device 20 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 410, whereby further processing may be performed based on data included in the detection signal. The motion sensor 408 can work in conjunction with a Global Positioning System (GPS) section 460. The information of the present position detected by the GPS section 460 is transmitted to the controller 410. An antenna 461 is connected to the GPS section 460 for receiving and transmitting signals to and from a GPS satellite.

The user device 20 may include a camera section 409, which includes a lens and shutter for capturing photographs of the surroundings around the user device 20. In an embodiment, the camera section 409 captures surroundings of an opposite side of the user device 20 from the user. The images of the captured photographs can be displayed on the display panel 420. A memory section saves the captured photographs. The memory section may reside within the camera section 109 or it may be part of the memory 450. The camera section 409 can be a separate feature attached to the user device 20 or it can be a built-in camera feature.

An example of a type of computer is shown in FIG. 7. The computer 500 can be used for the operations described in association with any of the computer-implement methods described previously, according to one implementation. For example, the computer 500 can be an example of a central computing device such as the mapping server 100 including processing circuitry, as discussed herein. The computer 500 can be an example of any of the devices in communication with the mapping server 100 via a communication network. The processing circuitry includes one or more of the elements discussed next with reference to FIG. 7. In FIG. 7, the computer 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the computer 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the computer 500. In one implementation, the storage device 530 is a computer-readable medium. In various different implementations, the storage device 530 may be a floppy disk device, a hard disk device, an optical disk device, or a tape device.

The input/output device 540 provides input/output operations for the computer 500. In one implementation, the input/output device 540 includes a keyboard and/or pointing device. In another implementation, the input/output device 540 includes a display unit for displaying graphical user interfaces.

Next, a hardware description of a device 601 according to an embodiment is described with reference to FIG. 8. In FIG. 8, the device 601, which can be any of the above described devices, including the mapping server 100, any of the devices 101, 105, 111, 112 including processing circuitry. The processing circuitry includes one or more of the elements discussed next with reference to FIG. 8. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device 601 communicates, such as a server or computer.

Further, the claimed advancements may be provided as a utility application, background daemon, or component of an operating system, or combination thereof, executing in conjunction with CPU 600 and an operating system such as Microsoft Windows, UNIX, Solaris, LINUX, Apple MAC-OS and other systems known to those skilled in the art.

The hardware elements in order to achieve the device 601 may be realized by various circuitry elements, known to those skilled in the art. For example, CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the processes described above.

The device 601 in FIG. 8 also includes a network controller 606, such as an Intel Ethernet PRO network interface card from Intel Corporation of America, for interfacing with network 650. and to communicate with the other devices. As can be appreciated, the network 650 can be a public network, such as the Internet, or a private network such as an LAN or WAN network, or any combination thereof and can also include PSTN or ISDN sub-networks. The network 650 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device 601 further includes a display controller 608, such as a NVIDIA GeForce GTX or Quadro graphics adaptor from NVIDIA Corporation of America for interfacing with display 610, such as an LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners.

A sound controller 620 is also provided in the device 601 to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the device 601. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Embodiments of the present disclosure may also be set forth in the following parentheticals.
(1) A method for generating a radiofrequency map, comprising: receiving, via processing circuitry, a set of received signal strength indicator (RSSI) data from a first device in an indoor environment based on signals received by the first device from one or more transmitters in the indoor environment; receiving, via the processing circuitry, sensor data from the first device in the indoor environment; determining, via the processing circuitry, location data of the first device in the indoor environment based on the sensor data; and generating, via the processing circuitry, a map of predicted RSSI data corresponding to locations in the indoor environment using an artificial intelligence model, the artificial intelligence model being trained on training data, the training data including the received set of RSSI data and the location data.
(2) The method of (1), wherein the sensor data includes light detection and ranging (LIDAR) data.
(3) The method of (1) to (2), wherein the sensor data includes accelerometer data, gyroscope data, and/or imaging data.
(4) The method of (1) to (3), wherein the one or more transmitters are Bluetooth emitters, WiFi emitters, ultra-wideband (UWB) signal emitters, or Zigbee signal emitters.
(5) The method of (1) to (4), further comprising receiving, via the processing circuitry, a second set of RSSI data from a second device in the indoor environment based on signals received by the second device, the training data further including the second set of RSSI data.
(6) The method of (1) to (5), wherein the second device is one of the one or more transmitters.
(7) The method of (1) to (6), further comprising identifying an area of signal interference in the indoor environment based on the map of predicted RSSI data.
(8) The method of (1) to (7), further comprising receiving, via the processing circuitry, a target set of RSSI data from a second device in the indoor environment based on signals received by the second device and predicting a location of the second device in the indoor environment based on the target set of RSSI data and the map of predicted RSSI data.
(9) A device comprising: processing circuitry configured to receive a set of received signal strength indicator (RSSI) data from a first device in an indoor environment based on signals received by the first device from one or more transmitters in the indoor environment, receive sensor data from the first device in the indoor environment, determine location data of the first device in the indoor environment based on the sensor data, and generate a map of predicted RSSI data corresponding to locations in the indoor environment using an artificial intelligence model, the artificial intelligence model being trained on the received set of RSSI data and the location data.
(10) The device of (9), wherein the sensor data includes light detection and ranging (LIDAR) data.
(11) The device of (9) to (10), wherein the sensor data includes accelerometer data, gyroscope data, and/or imaging data.
(12) The device of (9) to (11), wherein the one or more transmitters are Bluetooth emitters, WiFi emitters, ultra-wideband (UWB) signal emitters, or Zigbee signal emitters.
(13) The device of (9) to (12), further comprising receiving, via the processing circuitry, a second set of RSSI data from a second device in the indoor environment based on signals received by the second device, the training data further including the second set of RSSI data.
(14) A non-transitory computer-readable storage medium for storing computer-readable instructions that, when executed by a computer, cause the computer to perform a method, the method comprising: receiving a set of received signal strength indicator (RSSI) data from a first device in an indoor environment based on signals received by the first device from one or more transmitters in the indoor environment; receiving sensor data from the first device in the indoor environment; determining location data of the first device in the indoor environment based on the sensor data; and generating a map of predicted RSSI data corresponding to locations in the indoor environment using an artificial intelligence model, the artificial intelligence model being trained on training data, the training data including the received set of RSSI data and the location data.
(15) The non-transitory computer-readable storage medium of (14), wherein the sensor data includes light detection and ranging (LIDAR) data.
(16) The non-transitory computer-readable storage medium of (14) to (15), wherein the sensor data includes accelerometer data, gyroscope data, and/or imaging data.
(17) The non-transitory computer-readable storage medium of (14) to (16), wherein the one or more transmitters are Bluetooth emitters, WiFi emitters, ultra-wideband (UWB) signal emitters, or Zigbee signal emitters.
(18) The non-transitory computer-readable storage medium of (14) to (17), the method further comprising receiving, via the processing circuitry, a second set of RSSI data from a second device in the indoor environment based on signals received by the second device, the training data further including the second set of RSSI data.
(19) The non-transitory computer-readable storage medium of (14) to (18), wherein the second device is one of the one or more transmitters.
(20) The non-transitory computer-readable storage medium of (14) to (19), the method further comprising identifying an area of signal interference in the indoor environment based on the map of predicted RSSI data.
(21) The method of (1) to (8), wherein the generating the map of predicted RSSI data includes classifying the sensor data using a machine learning classifier and interpolating the set of RSSI data corresponding to the classified sensor data.
(22) The method of (1) to (8) and (21), further comprising receiving, via the processing circuitry, a target set of RSSI data from a second device in the indoor environment based on signals received by the second device and predicting a location of the second device in the indoor environment based on the target set of RSSI data and the map of predicted RSSI data using a support vector machine.
(23) The device of (9) to (13), wherein the processing circuitry is further configured to generate the map of predicted RSSI data by classifying the sensor data using a machine learning classifier and interpolating the set of RSSI data corresponding to the classified sensor data.
(24) The non-transitory computer-readable storage medium of (14) to (20), wherein the generating the map of predicted RSSI data includes classifying the location data and interpolating the received set of RSSI data based on the classified location data.

(25) The non-transitory computer-readable storage medium of (14) to (20) and (24), the method further comprising receiving a target set of RSSI data from a second device in the indoor environment based on signals received by the second device and predicting a location of the second device in the indoor environment based on the target set of RSSI data and the map of predicted RSSI data using a support vector machine.

Obviously, numerous modifications and variations of the present invention are possible in light of the above teachings. It is therefore to be understood that within the scope of the appended claims, the invention may be practiced otherwise than as specifically described herein.

1. A method for generating a radiofrequency map, comprising:
receiving, via processing circuitry, a set of received signal strength indicator (RSSI) data from a first device in an indoor environment based on signals received by the first device from one or more transmitters in the indoor environment;
receiving, via the processing circuitry, sensor data from the first device in the indoor environment;
determining, via the processing circuitry, location data of the first device in the indoor environment based on the sensor data; and
generating, via the processing circuitry, a map of predicted RSSI data corresponding to locations in the indoor environment using an artificial intelligence model, the artificial intelligence model being trained on training data, the training data including the received set of RSSI data and the location data.

2. The method of claim 1, wherein the sensor data includes light detection and ranging (LIDAR) data.

3. The method of claim 1, wherein the sensor data includes accelerometer data, gyroscope data, and/or imaging data.

4. The method of claim 1, wherein the one or more transmitters are Bluetooth emitters, WiFi emitters, ultra-wideband (UWB) signal emitters, or Zigbee signal emitters.

5. The method of claim 1, further comprising receiving, via the processing circuitry, a second set of RSSI data from a second device in the indoor environment based on signals received by the second device, the training data further including the second set of RSSI data.

6. The method of claim 1, wherein the generating the map of predicted RSSI data includes classifying the sensor data using a machine learning classifier and interpolating the set of RSSI data corresponding to the classified sensor data.

7. The method of claim 1, further comprising identifying an area of signal interference in the indoor environment based on the map of predicted RSSI data.

8. The method of claim 1, further comprising receiving, via the processing circuitry, a target set of RSSI data from a second device in the indoor environment based on signals received by the second device and predicting a location of the second device in the indoor environment based on the target set of RSSI data and the map of predicted RSSI data using a support vector machine.

9. A device comprising:
processing circuitry configured to
receive a set of received signal strength indicator (RSSI) data from a first device in an indoor environment based on signals received by the first device from one or more transmitters in the indoor environment,
receive sensor data from the first device in the indoor environment,
determine location data of the first device in the indoor environment based on the sensor data, and
generate a map of predicted RSSI data corresponding to locations in the indoor environment using an artificial intelligence model, the artificial intelligence model being trained on the received set of RSSI data and the location data.

10. The device of claim 9, wherein the sensor data includes light detection and ranging (LIDAR) data.

11. The device of claim 9, wherein the sensor data includes accelerometer data, gyroscope data, and/or imaging data.

12. The device of claim 9, wherein the one or more transmitters are Bluetooth emitters, WiFi emitters, ultra-wideband (UWB) signal emitters, or Zigbee signal emitters.

13. The device of claim 9, wherein the processing circuitry is further configured to generate the map of predicted RSSI data by classifying the sensor data using a machine learning classifier and interpolating the set of RSSI data corresponding to the classified sensor data.

14. A non-transitory computer-readable storage medium for storing computer-readable instructions that, when executed by a computer, cause the computer to perform a method, the method comprising:
receiving a set of received signal strength indicator (RSSI) data from a first device in an indoor environment based on signals received by the first device from one or more transmitters in the indoor environment;
receiving sensor data from the first device in the indoor environment;
determining location data of the first device in the indoor environment based on the sensor data; and
generating a map of predicted RSSI data corresponding to locations in the indoor environment using an artificial intelligence model, the artificial intelligence model being trained on training data, the training data including the received set of RSSI data and the location data.

15. The non-transitory computer-readable storage medium of claim 14, wherein the sensor data includes light detection and ranging (LIDAR) data.

16. The non-transitory computer-readable storage medium of claim 14, wherein the sensor data includes accelerometer data, gyroscope data, and/or imaging data.

17. The non-transitory computer-readable storage medium of claim 14, wherein the one or more transmitters are Bluetooth emitters, WiFi emitters, ultra-wideband (UWB) signal emitters, or Zigbee signal emitters.

18. The non-transitory computer-readable storage medium of claim 14, the method further comprising receiving, via the processing circuitry, a second set of RSSI data from a second device in the indoor environment based on signals received by the second device, the training data further including the second set of RSSI data.

19. The non-transitory computer-readable storage medium of claim 14, wherein the generating the map of predicted RSSI data includes classifying the location data and interpolating the received set of RSSI data based on the classified location data.

20. The non-transitory computer-readable storage medium of claim 14, the method further comprising receiving a target set of RSSI data from a second device in the indoor environment based on signals received by the second device and predicting a location of the second device in the indoor environment based on the target set of RSSI data and the map of predicted RSSI data using a support vector machine.
